(19) United States
(12) Patent Application Publication
(10) Pub. No.: US 2019/0236440 A1
(43) Pub. Date: Aug. 1, 2019

(54) DEEP CONVOLUTIONAL NEURAL NETWORK ARCHITECTURE AND SYSTEM AND METHOD FOR BUILDING THE DEEP CONVOLUTIONAL NEURAL NETWORK ARCHITECTURE

(71) Applicants: Pin-Han HO, Waterloo (CA); Zhi CHEN, Montreal (CA)

(72) Inventors: Pin-Han HO, Waterloo (CA); Zhi CHEN, Montreal (CA)

(21) Appl. No.: 16/263,874

(22) Filed: Jan. 31, 2019

Related U.S. Application Data
(60) Provisional application No. 62/709,751, filed on Jan. 31, 2018.

(51) Int. Cl. G06N 3/04; G06N 3/08; G06K 9/62; G06F 17/12

(52) U.S. Cl. CPC G06N 3/0472; G06F 17/12; G06K 9/6267; G06N 3/084

(57) ABSTRACT

An artificial convolutional neural network is described. The network includes a plurality of pooled convolutional layers connected sequentially, each pooled convolutional layer taking an input and generating an output, each pooled convolutional layer includes: at least one convolutional layer to apply to the input at least one convolutional operation using an activation function; and a pooling layer to apply a pooling operation to the at least one convolutional layer to generate the output; a plurality of global average pooling layers each linked to the output of a respective one of the plurality of pooled convolutional layers, each global average pooling layer to apply a global average pooling operation to the output of the respective pooled convolutional layer; a terminal hidden layer to combine the outputs of the global average pooling layers; and a softmax layer to apply a softmax operation to the output of the terminal hidden layer.

### TECHNICAL FIELD

The following relates generally to artificial neural networks and more specifically to a system and method for building a deep convolutional neural network architecture.

### BACKGROUND

Deep convolutional neural networks (CNN) are generally recognized as a powerful tool for computer vision and other applications. For example, deep CNNs have been found to be able to extract rich hierarchal features from raw pixel values and achieve amazing performance for classification and segmentation tasks in computer vision. However, existing approaches to deep CNN can be subject to various problems; for example, losing features learned at an intermediate hidden layer and a gradient vanishing problem.

### SUMMARY

In an aspect, there is provided an artificial convolutional neural network executable on one or more computer processors, the artificial convolutional neural network comprising: a plurality of pooled convolutional layers connected sequentially, each pooled convolutional layer taking an input and generating a pooled output, each pooled convolutional layer comprising: a convolutional block comprising at least one convolutional layer configured to apply to the input at least one convolutional operation using an activation function; and a pooling layer configured to apply a pooling operation to the convolutional block to generate the pooled output; a final convolutional block configured to receive as input the pooled output of the last sequentially connected pooled convolutional layer, the final convolutional block comprising at least one convolutional layer configured to apply to the input at least one convolutional operation using the activation function; a plurality of global average pooling layers each linked to the output of one of the convolutional blocks or the final convolutional block, each global average pooling layer configured to apply a global average pooling operation to the output of the convolutional block or final convolutional block; a terminal hidden layer configured to combine the outputs of the global average pooling layers; and a softmax layer configured to apply a softmax operation to the output of the terminal hidden layer.

In a particular case, the activation function is a multi-piecewise linear function.

In another case, each piece of the activation function is based on which of a plurality of endpoint ranges the input falls into, the endpoints being a learnable parameter.

In yet another case, if the input falls into a centre range of the endpoints, the activation function is an identity mapping, and otherwise, the activation function is a linear function based on the range of endpoints and a respective slope, the respective slope being a learnable parameter.

In yet another case, the activation function comprises:

$$y ( x ) = \{ \begin{matrix}{l}_{1} + {\sum }_{i = 1}^{n - 1} {k}_{i} ( {l}_{i + 1} - {l}_{i} ) + {k}_{n} ( x - {l}_{n} ) , & if x ∈ [ {l}_{n} , ∞ ) ; \\ ⋮ & \\ {l}_{1} + {k}_{1} ( x - {l}_{1} ) , & if x ∈ [ {l}_{1} , {l}_{2} ) ; \\ x & if x ∈ [ {l}_{- 1} , {l}_{1} ) ; \\ {l}_{- 1} + {k}_{- 1} ( x - {l}_{- 1} ) , & if x ∈ [ {l}_{- 2} , {l}_{- 1} ) ; \\ ⋮ & \\ {l}_{- 1} + {\sum }_{i = 1}^{n - 1} {k}_{- i} ( {l}_{- ( i + 1 )} - {l}_{- i} ) + {k}_{- n} ( x - {l}_{- n} ) , & if x ∈ ( - ∞ , {l}_{- n} ) .\end{matrix}$$

In yet another case, back propagation with gradient decent is applied to the layers of the artificial convolutional neural network using a multi-piecewise linear function.

In yet another case, if a back propagated output falls into a centre range of the endpoints, the back propagation function is one, and otherwise, the back propagation function is based on a respective slope, the respective slope being a learnable parameter.

In yet another case, the multi-piecewise linear function for back propagation comprises:

$$y ( x ) x = \{ \begin{matrix}{k}_{n} , & if x ∈ [ {l}_{n} , ∞ ) ; \\ ⋮ & \\ {k}_{1} , & if x ∈ [ {l}_{1} , {l}_{2} ) ; \\ 1 , & if x ∈ [ {l}_{- 1} , {l}_{1} ) ; \\ {k}_{- 1} , & if x ∈ [ {l}_{- 2} , {l}_{- 1} ) ; \\ ⋮ & \\ {k}_{- n} , & if x ∈ ( - ∞ , {l}_{- n} ) .\end{matrix}$$

In yet another case, the global average pooling comprises flattening the output to a one-dimensional vector via concatenation.

In yet another case, combining the inputs to the terminal block comprises generating a final weight matrix of each of the one-dimensional vectors inputted to the terminal block.

In another aspect, there is provided a system for executing an artificial convolutional neural network, the system comprising one or more processors and one or more non-transitory computer storage media, the one or more non-transitory computer storage media causing the one or more processors to execute: an input module to receive training data; a convolutional neural network module to: pass at least a portion of the training data to a plurality of pooled convolutional layers connected sequentially, each pooled convolutional layer taking an input and generating a pooled output, each pooled convolutional layer comprising: a convolutional block comprising at least one convolutional layer configured to apply to the input at least one convolutional operation using an activation function; and a pooling layer configured to apply a pooling operation to the convolutional block to generate the pooled output; pass the output of the last sequentially connected pooled convolutional layer to a final convolutional block, the final convolutional block comprising at least one convolutional layer configured to apply to the input at least one convolutional operation using the activation function; pass the output of each of the plurality of convolutional blocks and the output of the final convolutional block to a respective one of a plurality of global average pooling layers, each global average pooling layer configured to apply a global average pooling operation to the output of the respective convolutional block; pass the outputs of the global average pooling layers to a terminal hidden layer, the terminal hidden layer configured to combine the outputs of the global average pooling layers; and pass the output of the terminal hidden layer to a softmax layer, the softmax layer configured to apply a softmax operation to the output of the terminal hidden layer; an output module to output the output of the softmax operation.

In a particular case, the activation function is a multi-piecewise linear function.

In another case, each piece of the activation function is based on which of a plurality of endpoint ranges the input falls into, the endpoints being a learnable parameter.

In yet another case, if the input falls into a centre range of the endpoints, the activation function is an identity mapping, and otherwise, the activation function is a linear function based on the range of endpoints and a respective slope, the respective slope being a learnable parameter.

In yet another case, the activation function comprises:

$$y ( x ) = \{ \begin{matrix}{l}_{1} + {\sum }_{i = 1}^{n - 1} {k}_{i} ( {l}_{i + 1} - {l}_{i} ) + {k}_{n} ( x - {l}_{n} ) , & if x ∈ [ {l}_{n} , ∞ ) ; \\ ⋮ & \\ {l}_{1} + {k}_{1} ( x - {l}_{1} ) , & if x ∈ [ {l}_{1} , {l}_{2} ) ; \\ x & if x ∈ [ {l}_{- 1} , {l}_{1} ) ; \\ {l}_{- 1} + {k}_{- 1} ( x - {l}_{- 1} ) , & if x ∈ [ {l}_{- 2} , {l}_{- 1} ) ; \\ ⋮ & \\ {l}_{- 1} + {\sum }_{i = 1}^{n - 1} {k}_{- i} ( {l}_{- ( i + 1 )} - {l}_{- i} ) + {k}_{- n} ( x - {l}_{- n} ) , & if x ∈ ( - ∞ , {l}_{- n} ) .\end{matrix}$$

In yet another case, the CNN module further performs back propagation with gradient descent using a multi-piecewise linear function.

In yet another case, if a back propagated output falls into a centre range of the endpoints, the back propagation function is one, and otherwise, the back propagation function is based on a respective slope, the respective slope being a learnable parameter.

In yet another case, the multi-piecewise linear function for back propagation comprises:

$$y ( x ) x = \{ \begin{matrix}{k}_{n} , & if x ∈ [ {l}_{n} , ∞ ) ; \\ ⋮ & \\ {k}_{1} , & if x ∈ [ {l}_{1} , {l}_{2} ) ; \\ 1 , & if x ∈ [ {l}_{- 1} , {l}_{1} ) ; \\ {k}_{- 1} , & if x ∈ [ {l}_{- 2} , {l}_{- 1} ) ; \\ ⋮ & \\ {k}_{- n} , & if x ∈ ( - ∞ , {l}_{- n} ) .\end{matrix}$$

In yet another case, the global average pooling comprises flattening the output to a one-dimensional vector via concatenation.

In yet another case, combining the inputs to the terminal block comprises generating a final weight matrix of each of the one-dimensional vectors inputted to the terminal block.

These and other aspects are contemplated and described herein. It will be appreciated that the foregoing summary sets out representative aspects of a system and method for training a residual neural network and assists skilled readers in understanding the following detailed description.

### DESCRIPTION OF THE DRAWINGS

A greater understanding of the embodiments will be had with reference to the Figures, in which:

FIG. 1 is a schematic diagram of a system for building a deep convolutional neural network architecture, in accordance with an embodiment;

FIG. 2 is a schematic diagram showing the system of FIG. 1 and an exemplary operating environment;

FIG. 3 is a flow chart of a method for building a deep convolutional neural network architecture, in accordance with an embodiment;

FIG. 4A is a diagram of an embodiment of a deep convolutional neural network architecture;

FIG. 4B is a diagram of a cascading deep convolutional neural network architecture; and

FIG. 5 is a chart illustrating a comparison of error rate for the system of FIG. 1 and a previous approach, in accordance with an example experiment.

### DETAILED DESCRIPTION

Embodiments will now be described with reference to the figures. For simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Any module, unit, component, server, computer, terminal or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Any application or module herein described may be implemented using computer readable/executable instructions that may be stored or otherwise held by such computer readable media.

A CNN usually consists of several cascaded convolutional layers, comprising fully-connected artificial neurons. In some cases, it can also include pooling layers (average pooling or max pooling). In some cases, it can also include activation layers. In some cases, a final layer can be a softmax layer for classification and/or detection tasks. The convolutional layers are generally utilized to learn the spatial local-connectivity of input data for feature extraction. The pooling layer is generally for reduction of receptive field and hence to protect against overfitting. Activations, for example nonlinear activations, are generally used for boosting of learned features. Various variants to the standard CNN architecture can use deeper (more layers) and wider (larger layer size) architectures. To avoid overfitting for deep neural networks, some regularization methods can be used, such as dropout or dropconnect; which turn off neurons learned with a certain probability in training and prevent the co-adaptation of neurons during the training phase.

Part of the success of some approaches to deep CNN architecture is the use of appropriate nonlinear activation functions that define the value transformation from the input to output. It has been found that a rectified linear unit (ReLU) applying a linear rectifier activation function can greatly boost performance of CNN in achieving higher accuracy and faster convergence speed, in contrast to its saturated counterpart functions; i.e., sigmoid and tan h functions. ReLU only applies identity mapping on the positive side while dropping the negative input, allowing efficient gradient propagation in training. Its simple functionality enables training on deep neural networks without the requirement of unsupervised pre-training and can be used for implementations of very deep neural networks. However, a drawback of ReLU is that the negative part of the input is simply dropped and not updated in training in backward propagation. This can cause the problem of dead neurons (unutilized processing units/nodes) which may never be reactivated again and potentially result in lost feature information through the back-propagation. To alleviate this problem, other types of activation functions, based on ReLU, can be used; for example, a Leaky ReLU assigns a non-zero slope to the negative part. However, Leaky ReLU uses a fixed parameter and does not update during learning. Generally, these other types of activation functions lack the ability to mimic complex functions on both positive and negative sides in order to extract necessary information relayed to the next level. Further approaches use a maxout function that selects the maximum among k linear functions for each neuron as the output. While the maxout function has the potential to mimic complex functions and perform well in practice, it takes much more parameters than necessary for training and thus is expensive in terms of computation and memory usage in real-time and mobile applications.

Another aspect of deep CNNs is the size of the network and the interconnection architecture of different layers. Generally, network size has a strong impact on the performance of the neural network, and thus, performance can generally be improved by simply increasing its size. Size can be increased by either depth (number of layers) or width (number of units/neurons in each layer). While this increase may work well where there is a massive amount of labeled training data, when the amount of labeled training data is small, this increase potentially leads to overfitting and can work poorly in an inference stage for unseen unlabeled data. Further, a large-size neural network requires large amounts of computing resources for training. A large size network, especially one where there is no necessity to be that large, can end up wasting valuable resources; as most learned parameters may finally be determined to be at or near zero and can instead be dropped. The embodiments described herein make better use of features learned at the hidden layers, in contrast to the cascaded structure CNN, to achieve better performance. In this way, an enhanced performance, such as those achieved with larger architectures, can be achieved with a smaller network size and less parameters.

Previous approaches to deep CNNs are generally subject to various problems. For example, features learned at an intermediate hidden layer could be lost at the last stage of the classifier after passing through many later layers. Another is the gradient vanishing problem, which could cause training difficulty or even infeasibility. The present embodiments are able to mitigate such obstacles by targeting the tasks of real-time classification on small-scale applications, with similar classification accuracy but much less parameters, compared with other approaches. For example, the deep CNN architecture of the present embodiments incorporates a globally connected network topology with a generalized activation function. Global average pooling (GAP) is then applied on the neurons of, for example, some hidden layers and the last convolution layers. The resultant vectors can then be concatenated together and fed into a softmax layer for classification. Thus, with only one classifier and one objective loss function for training, rich information can be retained in the hidden layers, while taking less parameters. In this way, efficient information flow in both forward and backward propagation stages is available, and the overfitting risk can be substantially avoided. Further, embodiments described herein provide an activation function that comprises several piecewise linear functions to approximate complex functions. Advantageously, the present inventors were able to experimentally determine that the present embodiments yields similar performance to other approaches with much less parameters; and thus requiring much less computing resources.

In the present embodiments, the present inventors exploit the fact that exploitation of hidden layer neurons in convolutional neural networks (CNN), incorporating a carefully designed activation function, can yield better classification results in, for example, the field of computer vision. The present embodiments provide a deep learning (DL) architecture that can advantageously mitigate the gradient-vanishing problem, in which the outputs of earlier hidden layer neurons could feed to the last hidden layer and then the softmax layer for classification. The present embodiments also provide a generalized piecewise linear rectifier function as the activation function that can advantageously approximate arbitrary complex functions via training of the parameters. Advantageously, the present embodiments have been determined with experimentation (using a number of object recognition and video action benchmark tasks, such as MNIST, CIFAR-10/100, SVHN and UCF YoutTube Action Video datasets) to achieve similar performance with significantly less parameters and a shallower network infrastructure. This is particularly advantageous because the present embodiments not only reduce training in terms of computation burden and memory usage, but it also can be applied to low-computation, low-memory mobile scenarios.

Advantageously, the present embodiments provide an architecture which makes full of use of features learned at hidden layers, and which avoids the gradient-vanishing problem to a greater extent in backpropagation than other approaches. The present embodiments present a generalized multi-piecewise ReLU activation function, which is able to approximate more complex and flexible functions than other approaches, and hence was experimentally found to perform well in practice.

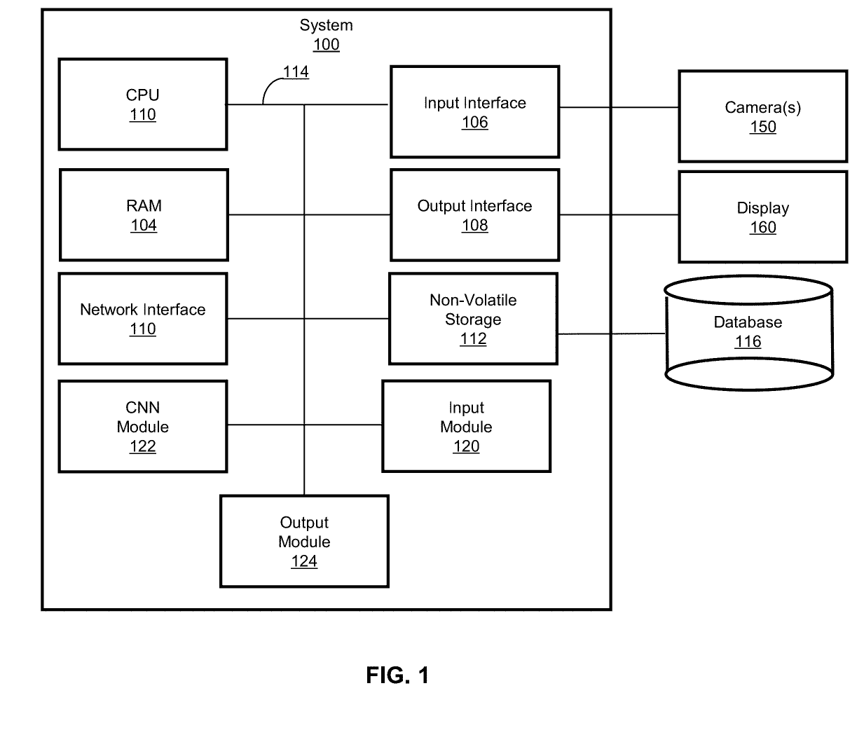

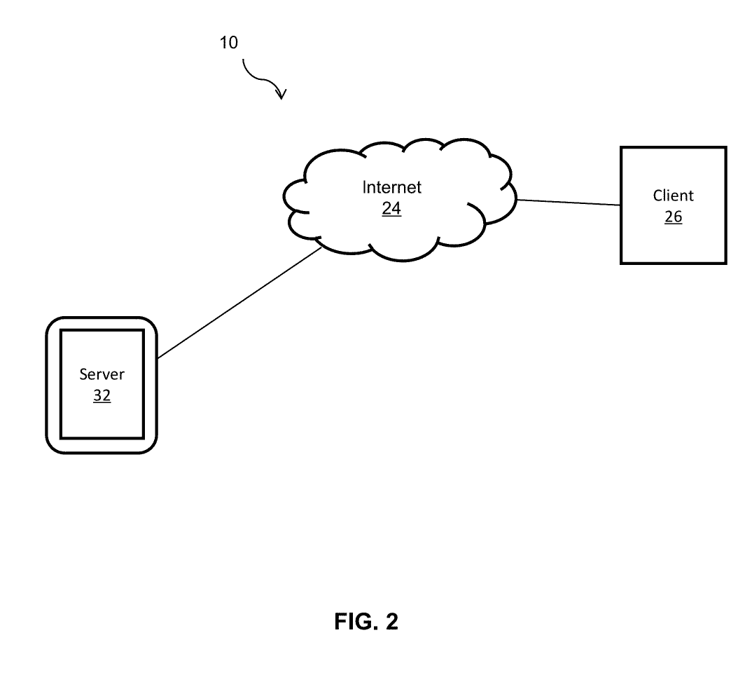

Referring now to FIG. 1 and FIG. 2, a system 100 for building a deep convolutional neural network architecture, in accordance with an embodiment, is shown. In this embodiment, the system 100 is run on a client side device 26 and accesses content located on a server 32 over a network 24, such as the internet. In further embodiments, the system 100 can be run on any other computing device; for example, a desktop computer, a laptop computer, a smartphone, a tablet computer, a server, a smartwatch, distributed or cloud computing device(s), or the like.

In some embodiments, the components of the system 100 are stored by and executed on a single computer system. In other embodiments, the components of the system 100 are distributed among two or more computer systems that may be locally or remotely distributed.

FIG. 1 shows various physical and logical components of an embodiment of the system 100. As shown, the system 100 has a number of physical and logical components, including a central processing unit (“CPU”) 102 (comprising one or more processors), random access memory (“RAM”) 104, an input interface 106, an output interface 108, a network interface 110, non-volatile storage 112, and a local bus 114 enabling CPU 102 to communicate with the other components. CPU 102 executes an operating system, and various modules, as described below in greater detail. RAM 104 provides relatively responsive volatile storage to CPU 102. The input interface 106 enables an administrator or user to provide input via an input device, for example a keyboard and mouse. The input interface 106 can be used to receive image data from one or more cameras 150. In other cases, the image data can be already located on the database 116 or received via the network interface 110. The output interface 108 outputs information to output devices, for example, a display 160 and/or speakers. The network interface 110 permits communication with other systems, such as other computing devices and servers remotely located from the system 100, such as for a typical cloud-based access model. Non-volatile storage 112 stores the operating system and programs, including computer-executable instructions for implementing the operating system and modules, as well as any data used by these services. Additional stored data, as described below, can be stored in a database 116. During operation of the system 100, the operating system, the modules, and the related data may be retrieved from the non-volatile storage 112 and placed in RAM 104 to facilitate execution.

In an embodiment, the CPU 102 is configurable to execute an input module 120, a CNN module 122, and an output module 124. As described herein, the CNN module 122 is able to build and use an embodiment of a deep convolutional neural network architecture (referred to herein as a Global-Connected Net or a GC-Net). In various embodiments, a piecewise linear activation function can be used in connection with the GC-Net.

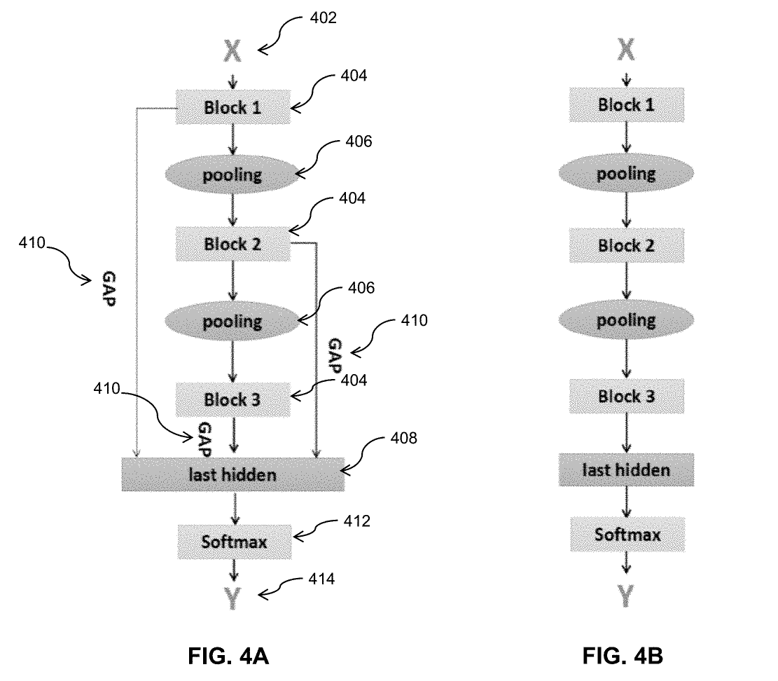

FIG. 4B illustrates an example CNN architecture with cascaded connected layers; where hidden blocks are pooled and then fed into a subsequent hidden block, and so on until a final hidden block followed by an output or softmax layer. FIG. 4A illustrates an embodiment of the GC-Net CNN architecture where inputs (X) 402 are fed into plurality of pooled convolutional layers connected sequentially. Each pooled convolutional layer includes a hidden block and a pooling layer. The hidden block includes at least one convolutional layer. A first hidden block 404 receives the input 402 and feeds into a first pooling layer 406. The pooling layer 406 feeds into a subsequent hidden block 404 which is then fed into a pooling layer 406, which is then fed into a further subsequent hidden block 404, and so on. The final output of this cascading or sequential structure has a global average pooling (GAP) layer applied and it is fed into a final (or terminal) hidden block 408. In addition to this cascading structure, this embodiment of the GC-Net CNN architecture also includes connecting the output of each hidden block 404 to a respective global average pooling (GAP) layer, which, for example, takes an average of each feature map from the last convolutional layer. Each GAP layer is then fed to the final hidden block 408. A softmax classifier 412 can then be used, the output of which can form the output (Y) 414 of the CNN.

As shown in FIG. 4A, the GC-Net architecture consists of n blocks 404 in total, a fully-connected final hidden layer 408 and a softmax classifier 412. In some cases, each block 404 can have several convolutional layers, each followed by normalization layers and activation layers. The pooling layers 406 can include max-pooling or average pooling layers to be applied between connected blocks to reduce feature map sizes. In this way, the GC-net network architecture provides a direct connection between each block 404 and the last hidden layer 408. These connections in turn create a relatively larger vector full of rich features captured from all blocks, which is fed as input into the last fully-connected hidden layer 408 and then to the softmax classifier 412 to obtain the classification probabilities in respective of labels. In some cases, to reduce the number of parameters in use, only one fully-connected hidden layer 408 is connected to the final softmax classifier 412 because it was determined that more dense layers generally only have minimal performance improvement while requiring a lot of extra parameters.

In embodiments of the GC-net architecture, for example to reduce the amount of parameters as well as computation bur den, a global average pooling (GAP) is applied to the output feature maps of each of the blocks 404, which are then connected to the last fully-connected hidden layer 408. In this sense, the neurons obtained from these blocks are flattened to obtain a 1-D vector for each block, i.e., \vec{p}ᵢ for block i (i=1, . . . , N) of length mᵢ. Concatenation operations can then be applied on those 1-D vectors, which results in a final 1-D vector consisting of neurons from these vectors,

$$i . e . , \vec{p} = \overleftarrow{{( {\vec{p}}_{1}^{T} , … , {\vec{p}}_{n}^{T} )}^{T}}$$

with its length defined as m=Σᵢ₌₁^{N}mᵢ. This resultant vector can be inputted to the last fully-connected hidden layer 408 before the softmax classifier 412 for classification. Therefore, to incorporate with this new feature vector, a weight matrix W_{m×s}_{_{c}}, =(Wₘ_{₁}_{×s}_{_{c}}, . . . , Wₘ_{_{N}}_{×s}_{_{c}}) for the final fully-connected layer can be used; where s_{c} is the number of classes of the corresponding dataset for recognition. In this embodiment, the final result fed into the softmax function can be denoted as:

\vec{c}^{T}=\vec{p}W=Σᵢ₌₁^{N}\vec{p}ᵢWᵢ (1)

i.e., \vec{c}=W^{T}\vec{p}^{T}, where Wᵢ=Wₘ_{ᵢ}_{×s}_{_{c}} for short. \vec{c}^{T} is the input vector into the softmax classifier, as well as the output of the fully-connected layer with \vec{p} as input.

Therefore, for back-propagation, dL/d\vec{c} can be defined as the gradient of the input fed to the softmax classifier 412 with respect to the loss function denoted by L, the gradient of the concatenated vector can be given by:

$$\frac{dL}{d \vec{p}} = \frac{dL}{d \vec{c}} \frac{d \vec{c}}{d \vec{p}} = {W}^{T} \frac{dL}{d \vec{c}} = ( \frac{dL}{d {\vec{p}}_{1}} , … , \frac{dL}{d {\vec{p}}_{n}} ) \qquad ( 2 )$$

Therefore, for the resultant vector \vec{p}ᵢ after pooling from the output of block i, its gradient dL/d\vec{p}ᵢ can be obtained directly from the softmax classifier.

Further, taking the cascaded back propagation process into account, except block n, in this embodiment, all other blocks will also receive the gradients from its following block in the backward pass. If the output of block i is defined as Bᵢ and the final gradient of the output of block i with respect to the loss function is defined as

$$\frac{dL}{d {B}_{i}} ,$$

then, taking both gradients from the final layer and the adjacent block of the cascaded structure into account,

$$\frac{dL}{d {\vec{B}}_{i}}$$

can be derived. The full gradient to the output of block i (i<n) with respect to the loss function is given by,

$$\frac{dL}{d {B}_{i}} = \frac{dL}{d {\vec{p}}_{i}} \frac{d {B}_{i}}{d {\vec{p}}_{i}} + ( \frac{dL}{d {\vec{p}}_{n}} \frac{d {\vec{B}}_{n}}{d {\vec{p}}_{n}} ) {\sum }_{j = i}^{n - 1} \frac{d {B}_{j + 1}}{d {B}_{j}} \qquad ( 3 )$$

where

$$\frac{d {B}_{j + 1}}{d {B}_{j}}$$

is defined as the gradient for the cascaded structure from block j+1 back-propagated to block of j and

$$\frac{d {B}_{i}}{d {\vec{p}}_{i}}$$

is the gradient of output of block i Bᵢ with respect to its pooled vector \vec{p}ᵢ. Each hidden block can receive gradients benefited from its direct connection with the last fully connected layer. Advantageously, the earlier hidden blocks can even receive more gradients, as it not only receives the gradients directly from the last layer, back-propagated from the standard cascaded structure, but also those gradients back-propagated from the following hidden blocks with respect to their direct connection with the final layer. Therefore, the gradient-vanishing problem can at least be mitigated. In this sense, the features generated in the hidden layer neurons are well exploited and relayed for classification.

The present embodiments of the CNN architecture have certain benefits over other approaches, for example, being able to build connections among blocks, instead of only within blocks. The present embodiments also differ from other approaches that use deep-supervised nets in which there are connections at every hidden layer with an independent auxiliary classifier (and not the final layer) for regularization but the parameters with these auxiliary classifiers are not used in the inference stage; hence these approaches can result in inefficiency of parameters utilization. In contrast, in the present embodiments, each block is allowed to connect with the last hidden layer that connects with only one final softmax layer for classification, for both the training and inference stages. The parameters are hence efficiently utilized to the greatest extent.

By employing global average pooling (i.e., using a large kernel size for pooling) prior to the global connection at the last hidden layer 408, the number of resultant features from the blocks 404 is greatly reduced; which significantly simplifies the structure and makes the extra number of parameters brought by this design minimal. Further, this does not affect the depth of the neural network, hence it has negligible impact on the overall computation overhead. It is further emphasized that, in back-propagation stage, each block can receive gradients coming from both the cascaded structure and directly from the generated 1-D vector as well, due to the connections between each block and the final hidden layer. Thus, the weights of the hidden layer can be better tuned, leading to higher classification performance.

In some embodiments, a piecewise linear activation function for CNN architectures can be used; for example, to be used with the GC-Net architecture described herein.

In an embodiment, the activation function (referred to herein as a Generalized Multi-Piecewise ReLU or GReLU) can be defined as a combination of multiple piecewise linear functions, for example:

$$y ( x ) = \{ \begin{matrix}{l}_{1} + {\sum }_{i = 1}^{n - 1} {k}_{i} ( {l}_{i + 1} - {l}_{i} ) + {k}_{n} ( x - {l}_{n} ) , & if x ∈ [ {l}_{n} , ∞ ) ; \\ ⋮ & \\ {l}_{1} + {k}_{1} ( x - {l}_{1} ) , & if x ∈ [ {l}_{1} , {l}_{2} ) ; \\ x & if x ∈ [ {l}_{- 1} , {l}_{1} ) ; \\ {l}_{- 1} + {k}_{- 1} ( x - {l}_{- 1} ) , & if x ∈ [ {l}_{- 2} , {l}_{- 1} ) ; \\ ⋮ & \\ {l}_{- 1} + {\sum }_{i = 1}^{n - 1} {k}_{- i} ( {l}_{- ( i + 1 )} - {l}_{- i} ) + {k}_{- n} ( x - {l}_{- n} ) , & if x ∈ ( - ∞ , {l}_{- n} ) .\end{matrix} \qquad ( 4 )$$

As defined in activation function (4), if the inputs fall into the center range of (l₋₁,l₁), the slope is set to be unity and the bias is set to be zero, i.e., identity mapping is applied. Otherwise, when the inputs are larger than l₁, i.e., they fall into one of the ranges on the positive direction in {(l₁,l₂), . . . , (lₙ₋₁, lₙ), (lₙ, ∞)}, slopes (k₁, . . . , kₙ) are assigned to those ranges, respectively. The bias can then be readily determined from the multi-piecewise linear structure of the designed function. Similarly, if the inputs fall into one of the ranges on the negative direction in {(l₋₁,l₋₂), . . . , (l₋₍ₙ₋₁₎, l₋ₙ), (l₋ₙ, −∞)}, (l₋₁, . . . , l₋₍ₙ₋₁,l₋ₙ) is assigned to those ranges, respectively. Advantageously, the useful features learned from linear mappings like convolution and fully-connected operations are boosted through the GReLU activation function.

In some cases, to fully exploit the multi-piecewise linear activation function, both the endpoints lᵢ and slopes kᵢ (i=−n, . . . , −1,1, . . . , n) can be set to be learnable parameters; and for simplicity and computation efficiency, it is restricted to channel-shared learning for the designed GReLU activation functions. In some cases, constraints are not imposed on the leftmost and rightmost points, which are then learned freely while the training is ongoing.

Therefore, for each activation layer, GRuLU only has 4n (n is the number of ranges on both directions) learnable parameters, where 2n accounts for the endpoints and another 2n for the slopes of the piecewise linear functions (which is generally negligible compared with millions of parameters in other deep CNN approaches). For example, GoogleNet has 5 million parameters and 22 layers. It is evident that, with increased n, GReLU can better approximate complex functions; while there may be additional computation resources consumed, in practice, even a small n (n=2) suffices for image/video classification tasks and thus the additional resources are manageable. In this way, n can be considered a constant parameter to be selected, taking into account the considerations that a large n will provide greater accuracy but require more computational resources. In some cases, different n values can be tested (and retested) to find a value that converges but is not overly burdensome on computational resources.

For training using the GReLU activation function, in an embodiment, gradient descent for back-propagation can be applied. The derivatives of the activation function with respect to the input as well as the learnable parameters are given as follows:

$$y ( x ) x = \{ \begin{matrix}{k}_{n} , & if x ∈ [ {l}_{n} , ∞ ) ; \\ ⋮ & \\ {k}_{1} , & if x ∈ [ {l}_{1} , {l}_{2} ) ; \\ 1 , & if x ∈ [ {l}_{- 1} , {l}_{1} ) ; \\ {k}_{- 1} , & if x ∈ [ {l}_{- 2} , {l}_{- 1} ) ; \\ ⋮ & \\ {k}_{- n} , & if x ∈ ( - ∞ , {l}_{- n} ) .\end{matrix} \qquad ( 5 )$$

where the derivative to the input is the slope of the associated linear mapping when the input falls in its range.

$$\begin{matrix}y ( x ) {k}_{i} = \{ \begin{matrix}\begin{matrix}( {l}_{i + 1} - {l}_{i} ) I \{ x > {l}_{i + 1} \} + \\ ( x - {l}_{i} ) I \{ {l}_{i} < x \leq {l}_{i + 1} \} ,\end{matrix} & if i ∈ \{ 1 , … , n - 1 \} ; \\ ( x - {l}_{i} ) I \{ x > {l}_{i} \} , & if i = n ; \\ ( x - {l}_{i} ) I \{ x \leq {l}_{i} \} , & if i = - n ; \\ \begin{matrix}( {l}_{i - 1} - {l}_{i} ) I \{ x < {l}_{i - 1} \} + \\ ( x - {l}_{i} ) I \{ {l}_{i - 1} < x \leq {l}_{i} \} ,\end{matrix} & if i ∈ \{ - n + 1 , … , - 1 \} .\end{matrix} & ( 6 ) \\ y ( x ) {l}_{i} = \{ \begin{matrix}( {k}_{i - 1} - {k}_{i} ) I \{ x > {l}_{i} \} , & if i > 1 ; \\ ( 1 - {k}_{1} ) I \{ x > {l}_{1} \} , & if i = 1 ; \\ ( 1 - {k}_{- 1} ) I \{ x <= {l}_{- 1} \} , & if i = - 1 ; \\ ( {k}_{i + 1} - {k}_{i} ) I \{ x <= {l}_{i} \} , & if i < - 1.\end{matrix} & ( 7 )\end{matrix}$$

where I{·} is an indication function returning unity when the event {·} happens and zero otherwise.

The back-propagation update rule for the parameters of GReLU activation function can be derived by chain rule as follows,

Loᵢ=ΣⱼLyⱼyⱼoᵢ (8)

where L is the loss function, yⱼ is the output of the activation function, and oᵢ∈{kᵢ,lᵢ} is the learnable parameters of GReLU. Note that the summation is applied in all positions and across all feature maps for the activated output of the current layer, as the parameters are channel-shared. Lyⱼ is defined as the derivative of the activated GReLU output back-propagated from the loss function through its upper layers. Therefore, an update rule for the learnable parameters of GReLU activation function is:

oᵢ←oᵢ−αLoᵢ (9)

where α is the learning rate. In this case, the weight decay (e.g., L2 regularization) is not taken into account in updating these parameters.

Embodiments of the GReLU activation function, as multi-piecewise linear functions, have several advantages. One is that it is enabled to approximate complex functions whether they are convex functions or not, while other activation functions generally do not have this capability and thus demonstrates a stronger capability in feature learning. Further, since it employs linear mappings in different ranges along the dimension, it inherits the advantage of the non-saturate functions, i.e., the gradient vanishing/exploding effect is mitigated to a great extent.

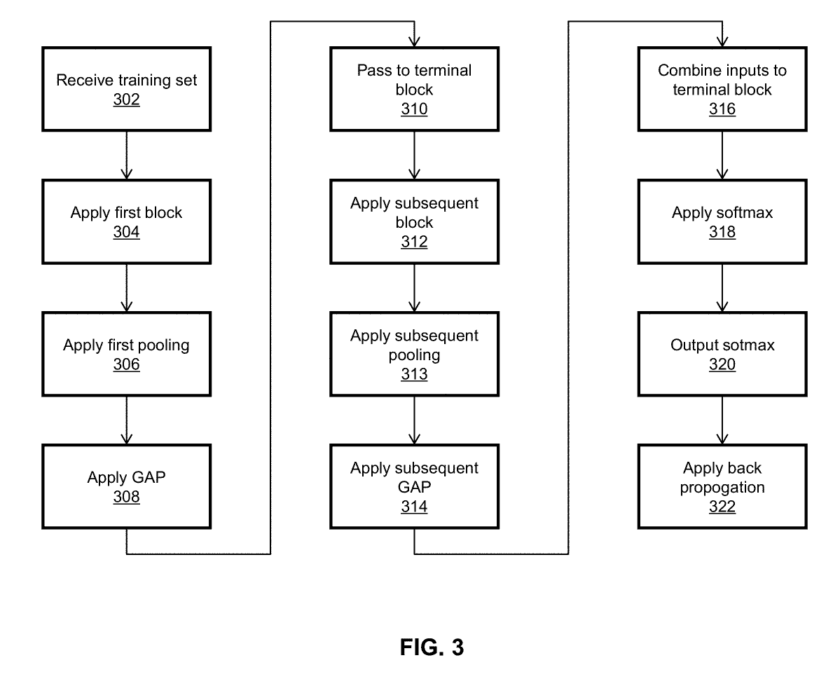

FIG. 3 illustrates a flowchart for a method 300 for building a deep convolutional neural network architecture, according to an embodiment.

At block 302, the input module 120 receives a training dataset. At least a portion of the dataset comprising training data.

At block 304, the CNN module 120 passes the training data to a first pooled convolutional layer comprising a first block in a convolutional neural network (CNN), the first block comprising at least one convolutional layer to apply at least one convolutional operation using an activation function.

At block 306, the CNN module 120 passes the output of the first block to a first pooling layer also part of the first pooled convolutional layer, the pooling layer applying a pooling operation.

At block 308, the CNN module 120 also performs global average pooling (GAP) on the output of the first block.

At block 310, the CNN module 120 passes the output of the first block having GAP applied to a terminal hidden block.

At block 312, the CNN module 120 iteratively passes the output of each of the subsequent sequentially connected pooled convolutional layers to the next pooled convolutional layer.

At block 314, the CNN module 120 performs global average pooling (GAP) on the output of each of the subsequent pooled convolutional layers and passes the output of the GAP to the terminal hidden block.

At block 316, the CNN module 120 outputs a combination of the inputs to the terminal hidden block as the output of the terminal hidden block.

At block 318, the CNN module 120 applies a softmax operation to the output of the terminal hidden block.

At block 320, the output module 122 outputs the output of the softmax operation to, for example, to the output interface 108 to the display 160, or to the database 116.

In some cases, the activation function can be a multi-piecewise linear function. In some cases, the particular linear function to apply can be based on which endpoint range the input falls into; for example, ranges can include one of: between endpoint −1 and 1, between endpoint 1 and 2, between −1 and −2, between 3 and infinity, and between −3 and negative infinity. In a particular case, the activation function is an identity mapping if the endpoint is between −1 and 1. In a particular case, the activation function is:

$$y ( x ) = \{ \begin{matrix}{l}_{1} + {\sum }_{i = 1}^{n - 1} {k}_{i} ( {l}_{i + 1} - {l}_{i} ) + {k}_{n} ( x - {l}_{n} ) , & if x ∈ [ {l}_{n} , ∞ ) ; \\ ⋮ & \\ {l}_{1} + {k}_{1} ( x - {l}_{1} ) , & if x ∈ [ {l}_{1} , {l}_{2} ) ; \\ x & if x ∈ [ {l}_{- 1} , {l}_{1} ) ; \\ {l}_{- 1} + {k}_{- 1} ( x - {l}_{- 1} ) , & if x ∈ [ {l}_{- 2} , {l}_{- 1} ) ; \\ ⋮ & \\ {l}_{- 1} + {\sum }_{i = 1}^{n - 1} {k}_{- i} ( {l}_{- ( i + 1 )} - {l}_{- i} ) + {k}_{- n} ( x - {l}_{- n} ) , & if x ∈ ( - ∞ , {l}_{- n} ) .\end{matrix}$$

In some cases, the method 300 can further include back propagation 322. In some cases, the back propagation can use a multi-piecewise linear function. In some cases, the particular linear function to apply can be based on which endpoint range the back-propagated output falls into; for example, ranges can include one of: between endpoint −1 and 1, between endpoint 1 and 2, between −1 and −2, between 3 and infinity, and between −3 and negative infinity. In a particular case, the back propagation can include an identity mapping if the endpoint is between −1 and 1. In a particular case, the back propagation is:

$$y ( x ) x = \{ \begin{matrix}{k}_{n} , & if x ∈ [ {l}_{n} , ∞ ) ; \\ ⋮ & \\ {k}_{1} , & if x ∈ [ {l}_{1} , {l}_{2} ) ; \\ 1 , & if x ∈ [ {l}_{- 1} , {l}_{1} ) ; \\ {k}_{- 1} , & if x ∈ [ {l}_{- 2} , {l}_{- 1} ) ; \\ ⋮ & \\ {k}_{- n} , & if x ∈ ( - ∞ , {l}_{- n} ) .\end{matrix}$$

The present inventors conducted example experiments using the embodiments described herein. The experiments employed public datasets with different scales, MNIST, CIFAR10, CIFAR100, SVHN, and UCF YouTube Action Video datasets. Experiments were first conducted on small neural nets using the small dataset MNIST and the resultant performance was compared with other CNN schemes. Then larger CNNs were tested for performance comparison with other large CNN models, such as stochastic pooling, NIN and Maxout, for all the experimental datasets. In this case, the experiments were conducted using PYTORCH with one Nvidia GeForce GTX 1080.

The MNIST digit dataset contains 70,000 28×28 gray scale images of numerical digits from 0 to 9. The dataset is divided into the training set with 60,000 images and the test set with 10,000 images.

In the example small net experiment, MNIST was used for performance comparison. The experiment used the present embodiments of a GReLU activated GC-Net composed of 3 convolution layers with small 3×3 filters and 16, 16 and 32 feature maps, respectively. The 2×2 max pooling layer with a stride of 2×2 was applied after both of the first two convolution layers. GAP was applied to the output of each convolution layer and the collected averaged features were fed as input to the softmax layer for classification. The total number of parameters amounted to be only around 8.3K. For a comparison, the dataset was also examined using a 3-convolution-layer CNN with ReLU activation, with 16, 16 and 36 feature maps equipped in the three convolutional layers, respectively. Therefore, both tested networks used a similar amount of parameters (if not the same).

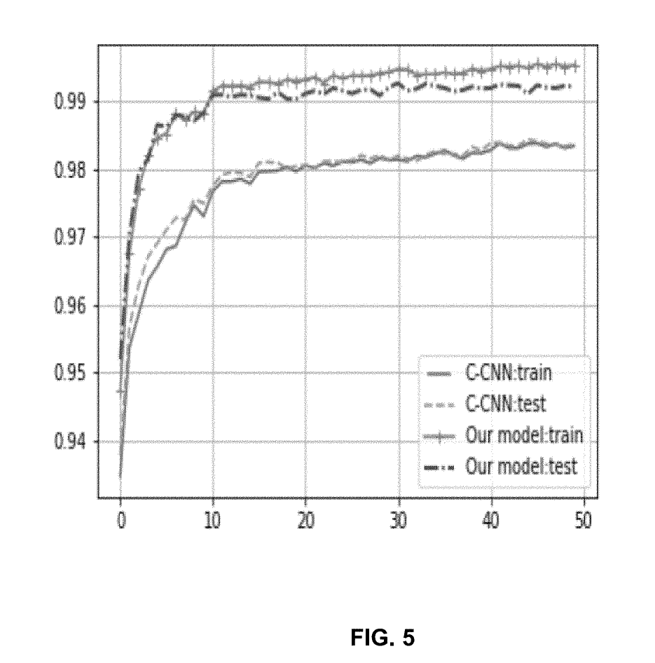

In MNIST, neither preprocessing nor data augmentation were performed on the dataset, except for re-scaling the pixel values to be within (−1,1) range. The results of the example experiment are shown in FIG. 5 (where “C-CNN” represents the results of the 3-convolution-layer CNN with ReLU activation and “Our model” represents the results of the GReLU activated GC-Net). For this example illustrated in FIG. 5, the ranges of sections are ((−∞, −0.6), (−0.6, −0.2), (−0.2,0.2), (0.2,0.6), (0.6, ∞)) and the corresponding slopes for these sections are (0.01, 0.2, 1, 1.5, 3), respectively. FIG. 5 shows that the proposed GReLU activated GC-Net achieves an error rate no larger than 0.78% compared with 1.7% by the other CNN, which is over 50% of improvement in accuracy, after a run of 50 epochs. It is also observed that the proposed architecture tends to converge fast, compared with its conventional counterpart. For the GReLU activated GC-Net, test accuracy exceeds below 1% error rate only starting from epoch 10, while the other CNN reaches similar performance only after epoch 15.

The present inventors also conducted other experiments on the MNIST dataset to further verify the performance of the present embodiments with relatively more complex models. The schemes were kept the same to achieve similar error rates while observing the required number of trained parameters. Again, a network with three convolutional layers was used while keeping all convolutional layers with 64 feature maps and 3×3 filters. The experiment results are shown in Table 1, where the proposed GC-Net with GReLU yields a similar error rate (i.e., 0.42% versus 0.47%) while taking only 25% of the total trained parameters by the other approaches. The results of the two experiments on MNIST clearly demonstrated the superiority of the proposed GReLU activated GC-Net over the traditional CNN schemes in these test cases. Further, with roughly 0.20M parameters, a relatively larger network with the present GC-Net architecture achieves high accuracy performance, i.e., 0.28% error rate, while a benchmark counterpart, DSN, achieves 0.39% error rate with a total of 0.35M parameters.

TABLE 1
Error rates on MNIST without data augmentation.

| Model | No. of Param. (MB) | Error Rates |
|---|---|---|
| Stochastic Pooling | 0.22M | 0.47% |
| Maxout | 0.42M | 0.47% |
| DSN + softmax | 0.35M | 0.51% |
| DSN + SVM | 0.35M | 0.39% |
| NIN + ReLU | 0.35M | 0.47% |
| NIN + SReLU | 0.35M + 5.68K | 0.35% |
| GReLU-GC-Net | 0.078M | 0.42% |
| GReLU-GC-Net | 0.22M | 0.27% |

For this example experiment, the CIFAR-10 dataset was also used that contains 60,000 natural color (RGB) images with a size of 32×32 in 10 general object classes. The dataset is divided into 50,000 training images and 10,000 testing images. A comparison of results of the GReLU activated GC-Net to other reported methods on this dataset, including stochastic pooling, maxout, prob maxout, and NIN, are given in Table. 2. It was observed that the present embodiments achieved comparable performance while taking greatly reduced number of parameters employed in other approaches. Advantageously, a shallow model with only 0.092M parameters in 3 convolution layers using the GC-Net architecture achieves comparable performance with convolution kernel methods. For the experiments with 6 convolution layers, with roughly 0.61M parameters, the GC-Net architecture achieved comparable performance in contrast to Maxout with SM parameters. Compared with NIN consisting of 9 convolution layers and roughly 1M parameters, the GC-Net architecture achieved competitive performance, only in a 6-convolution-layer shallow architecture with roughly 60% of parameters of it. These results demonstrate the advantage of using GReLU activated GC-Net, which accomplishes similar performance with less parameters and a shallower structure (less convolution layers required); and hence, is particularly advantageous for memory-efficient and computation-efficient scenarios, such as mobile applications.

TABLE 2
Error rates on CIFAR-10 without data augmentation.

| Model | No. of Param. (MB) | Error Rates |
|---|---|---|
| Conv kernel | — | 17.82% |
| Stochastic pooling | — | 15.13% |
| ResNet (110 layers) | 1.7M | 13.63% |
| ResNet (1001 layers) | 10.2M | 10.56% |
| Maxout | >5M | 11.68% |
| Prob Maxout | >5M | 11.35% |
| DSN (9 conv layers) | 0.97M | 9.78% |
| NIN (9 conv layers) | 0.97M | 10.41% |
| GReLU-GC-Net (3 conv layers) | 0.092M | 17.23% |
| GReLU-GC-Net (6 conv layers) | 0.11M | 12.55% |
| GReLU-GC-Net (6 conv layers) | 0.61M | 10.39% |
| GReLU-GC-Net (8 conv layers) | 0.91M | 9.38% |

The CIFAR-100 dataset also contains 60,000 natural color (RGB) images with a size of 32×32 but in 100 general object classes. The dataset is divided into 50,000 training images and 10,000 testing images. Example experiments on this dataset were implemented and a comparison of the results of the GC-Net architecture to other reported methods are given in Table 3. It is observed that the GC-Net architecture achieved comparable performance while taking greatly reduced number of parameters employed in the other models. As observed in Table 3, Advantageously, a shallow model with only 0.16M parameters in 3 convolution layers using the GC-Net architecture achieved comparable performance with deep ResNet of 1.6M parameters. In the experiments with 6 convolution layers, it is observed that, with roughly 10% of parameters in Maxout, the GC-Net architecture achieved comparable performance. In addition, with roughly 60% of parameters of NIN, the GC-Net architecture accomplished competitive (or even slightly higher) performance than the other approach; which however consists of 9 convolution layers (3 layers deeper than the compared model). This generally experimentally validates the powerful feature learning capabilities of the GC-net architecture with GReLU activations. In such way, it can achieve similar performance with shallower structure and less parameters.

TABLE 3
Error rates on CIFAR-100 without data augmentation.

| Model | No. of Param. (MB) | Error Rates |
|---|---|---|
| ResNet | 1.7M | 44.74% |
| Stochastic pooling | — | 42.51% |
| Maxout | >5M | 38.57% |
| Prob Maxout | >5M | 38.14% |
| DSN | 1M | 34.57% |
| NIN (9 conv layers) | 1M | 35.68% |
| GReLU-GC-Net (3 conv layers) | 0.16M | 44.79% |
| GReLU-GC-Net (6 conv layers) | 0.62M | 35.59% |
| GReLU-GC-Net (8 conv layers) | 0.95M | 33.87% |

The SVHN Data Set contains 630,420 RGB images of house numbers, collected by Google Street View. The images are of size 32×32 and the task is to classify the digit in the center of the image, however possibly some digits may appear beside it but are considered noise and ignored. This dataset was split into three subsets, i.e., extra set, training set, and test set, and each with 531,131, 73,257, and 26,032 images, respectively, where the extra set is a less difficult set used as an extra training set. Compared with MNIST, it is a much more challenging digit dataset due to its large color and illumination variations.

In this example experiment, the pixel values were re-scaled to be within (−1,1) range, identical to that imposed on MNIST. In this example, the GC-Net architecture of the present embodiments, with only 6 convolution layers and 0.61M parameters, achieved roughly the same performance with NIN, which consists of 9 convolution layers and around 2M parameters. Further, for deeper models with 9 layers and 0.90M parameters, the GC-Net architecture achieved superior performance, which validates the powerful feature learning capabilities of the GC-Net architecture. Table 4 illustrates results from the example experiment with the SVHN dataset.

TABLE 4
Error rates on SVHN.

| Model | No. of Param. (MB) | Error Rates |
|---|---|---|
| Stochastic pooling | — | 2.80% |
| Maxout | >5M | 2.47% |
| Prob Maxout | >5M | 2.39% |
| DSN | 1.98M | 1.92% |
| NIN (9 conv layers) | 1.98M | 2.35% |
| GReLU-GC-Net (6 conv layers) | 0.61M | 2.35% |
| GReLU-GC-Net (8 conv layers) | 0.90M | 2.10% |

The UCF YouTube Action Video Dataset is a video dataset for action recognition. It consists of approximately 1168 videos in total and contains 11 action categories, including: basketball shooting, biking/cycling, diving, golf swinging, horse back riding, soccer juggling, swinging, tennis swinging, trampoline jumping, volleyball spiking, and walking with a dog. For each category, the videos are grouped into 25 groups with over 4 action clips in it. The video clips belonging to the same group may share some common characteristics, such as the same actor, similar background, similar viewpoint, and so on. The dataset is split into training set and test set, each with 1,291 and 306 samples, respectively. It is noted that UCF YouTube Action Video Dataset is quite challenging due to large variations in camera motion, object appearance and pose, object scale, viewpoint, cluttered background, illumination conditions, and the like. For each video in this dataset, 16 non-overlapping frames clips were selected. Each frame was resized into 36×36 and then cropped and centered 32×32 for training. As illustrated in Table 5, the results of the experiment using the UCF YouTube Action Video Dataset show that the GC-Net architecture achieved higher performance than benchmark approaches using hybrid features.

TABLE 5
Error rates on UCF Youtube Action Video Dataset.

| Model | No. of Param. (MB) | Error Rates |
|---|---|---|
| Previous approach using static | — | 63.1% |
| features | | |
| Previous approach using motion | — | 65.4% |
| features | | |
| Previous approach using hybrid | — | 71.2% |
| features | | |
| GReLU-GC-Net | — | 72.6% |

The deep CNN architecture of the present embodiments advantageously make better use of the hidden layer features of the CNN to, for example, alleviate the gradient-vanishing problem. In combination with the piecewise linear activation function, experiments demonstrate that it is able to achieve state of the art performance in several object recognition and video action recognition benchmark tasks with a greatly reduced amount of parameters and a shallower structure. Advantageously, the present embodiments can be employed in small-scale real-time application scenarios, as it requires less parameters and shallower network structure.

Although the invention has been described with reference to certain specific embodiments, various modifications thereof will be apparent to those skilled in the art without departing from the spirit and scope of the invention as outlined in the claims appended hereto.

We claim:

1. An artificial convolutional neural network executable on one or more computer processors, the artificial convolutional neural network comprising:
a plurality of pooled convolutional layers connected sequentially, each pooled convolutional layer taking an input and generating a pooled output, each pooled convolutional layer comprising:
a convolutional block comprising at least one convolutional layer configured to apply to the input at least one convolutional operation using an activation function; and
a pooling layer configured to apply a pooling operation to the convolutional block to generate the pooled output;
a final convolutional block configured to receive as input the pooled output of the last sequentially connected pooled convolutional layer, the final convolutional block comprising at least one convolutional layer configured to apply to the input at least one convolutional operation using the activation function;
a plurality of global average pooling layers each linked to the output of one of the convolutional blocks or the final convolutional block, each global average pooling layer configured to apply a global average pooling operation to the output of the convolutional block or final convolutional block;
a terminal hidden layer configured to combine the outputs of the global average pooling layers; and
a softmax layer configured to apply a softmax operation to the output of the terminal hidden layer.

2. The artificial convolutional neural network of claim 1, wherein the activation function is a multi-piecewise linear function.

3. The artificial convolutional neural network of claim 2, wherein each piece of the activation function is based on which of a plurality of endpoint ranges the input falls into, the endpoints being a learnable parameter.

4. The artificial convolutional neural network of claim 3, wherein if the input falls into a centre range of the endpoints, the activation function is an identity mapping, and otherwise, the activation function is a linear function based on the range of endpoints and a respective slope, the respective slope being a learnable parameter.

5. The artificial convolutional neural network of claim 4, wherein the activation function comprises:
$$y ( x ) = \{ \begin{matrix}{l}_{1} + {\sum }_{i = 1}^{n - 1} {k}_{i} ( {l}_{i + 1} - {l}_{i} ) + {k}_{n} ( x - {l}_{n} ) , & if x ∈ [ {l}_{n} , ∞ ) ; \\ ⋮ & \\ {l}_{1} + {k}_{1} ( x - {l}_{1} ) , & if x ∈ [ {l}_{1} , {l}_{2} ) ; \\ x & if x ∈ [ {l}_{- 1} , {l}_{1} ) ; \\ {l}_{- 1} + {k}_{- 1} ( x - {l}_{- 1} ) , & if x ∈ [ {l}_{- 2} , {l}_{- 1} ) ; \\ ⋮ & \\ {l}_{- 1} + {\sum }_{i = 1}^{n - 1} {k}_{- i} ( {l}_{- ( i + 1 )} - {l}_{- i} ) + {k}_{- n} ( x - {l}_{- n} ) , & if x ∈ ( - ∞ , {l}_{- n} ) .\end{matrix}$$

6. The artificial convolutional neural network of claim 1, wherein back propagation with gradient decent is applied to the layers of the artificial convolutional neural network using a multi-piecewise linear function.

7. The artificial convolutional neural network of claim 6, wherein if a back propagated output falls into a centre range of the endpoints, the back propagation function is one, and otherwise, the back propagation function is based on a respective slope, the respective slope being a learnable parameter.

8. The method of claim 7, wherein the multi-piecewise linear function for back propagation comprises:
$$y ( x ) x = \{ \begin{matrix}{k}_{n} , & if x ∈ [ {l}_{n} , ∞ ) ; \\ ⋮ & \\ {k}_{1} , & if x ∈ [ {l}_{1} , {l}_{2} ) ; \\ 1 , & if x ∈ [ {l}_{- 1} , {l}_{1} ) ; \\ {k}_{- 1} , & if x ∈ [ {l}_{- 2} , {l}_{- 1} ) ; \\ ⋮ & \\ {k}_{- n} , & if x ∈ ( - ∞ , {l}_{- n} ) .\end{matrix}$$

9. The method of claim 1, wherein the global average pooling comprises flattening the output to a one-dimensional vector via concatenation.

10. The method of claim 9, wherein combining the inputs to the terminal block comprises generating a final weight matrix of each of the one-dimensional vectors inputted to the terminal block.

11. A system for executing an artificial convolutional neural network, the system comprising one or more processors and one or more non-transitory computer storage media, the one or more non-transitory computer storage media causing the one or more processors to execute:
an input module to receive training data;
a convolutional neural network module to:
pass at least a portion of the training data to a plurality of pooled convolutional layers connected sequentially, each pooled convolutional layer taking an input and generating a pooled output, each pooled convolutional layer comprising:
a convolutional block comprising at least one convolutional layer configured to apply to the input at least one convolutional operation using an activation function; and
a pooling layer configured to apply a pooling operation to the convolutional block to generate the pooled output;
pass the output of the last sequentially connected pooled convolutional layer to a final convolutional block, the final convolutional block comprising at least one convolutional layer configured to apply to the input at least one convolutional operation using the activation function;
pass the output of each of the plurality of convolutional blocks and the output of the final convolutional block to a respective one of a plurality of global average pooling layers, each global average pooling layer configured to apply a global average pooling operation to the output of the respective convolutional block;
pass the outputs of the global average pooling layers to a terminal hidden layer, the terminal hidden layer configured to combine the outputs of the global average pooling layers; and
pass the output of the terminal hidden layer to a softmax layer, the softmax layer configured to apply a softmax operation to the output of the terminal hidden layer; and
an output module to output the output of the softmax operation.

12. The system of claim 11, wherein the activation function is a multi-piecewise linear function.

13. The system of claim 12, wherein each piece of the activation function is based on which of a plurality of endpoint ranges the input falls into, the endpoints being a learnable parameter.

14. The system of claim 13, wherein if the input falls into a centre range of the endpoints, the activation function is an identity mapping, and otherwise, the activation function is a linear function based on the range of endpoints and a respective slope, the respective slope being a learnable parameter.

15. The system of claim 14, wherein the activation function comprises:
$$y ( x ) = \{ \begin{matrix}{l}_{1} + {\sum }_{i = 1}^{n - 1} {k}_{i} ( {l}_{i + 1} - {l}_{i} ) + {k}_{n} ( x - {l}_{n} ) , & if x ∈ [ {l}_{n} , ∞ ) ; \\ ⋮ & \\ {l}_{1} + {k}_{1} ( x - {l}_{1} ) , & if x ∈ [ {l}_{1} , {l}_{2} ) ; \\ x & if x ∈ [ {l}_{- 1} , {l}_{1} ) ; \\ {l}_{- 1} + {k}_{- 1} ( x - {l}_{- 1} ) , & if x ∈ [ {l}_{- 2} , {l}_{- 1} ) ; \\ ⋮ & \\ {l}_{- 1} + {\sum }_{i = 1}^{n - 1} {k}_{- i} ( {l}_{- ( i + 1 )} - {l}_{- i} ) + {k}_{- n} ( x - {l}_{- n} ) , & if x ∈ ( - ∞ , {l}_{- n} ) .\end{matrix}$$

16. The system of claim 11, wherein the CNN module further performs back propagation with gradient descent using a multi-piecewise linear function.

17. The system of claim 16, wherein if a back propagated output falls into a centre range of the endpoints, the back propagation function is one, and otherwise, the back propagation function is based on a respective slope, the respective slope being a learnable parameter.

18. The system of claim 17, wherein the multi-piecewise linear function for back propagation comprises:
$$y ( x ) x = \{ \begin{matrix}{k}_{n} , & if x ∈ [ {l}_{n} , ∞ ) ; \\ ⋮ & \\ {k}_{1} , & if x ∈ [ {l}_{1} , {l}_{2} ) ; \\ 1 , & if x ∈ [ {l}_{- 1} , {l}_{1} ) ; \\ {k}_{- 1} , & if x ∈ [ {l}_{- 2} , {l}_{- 1} ) ; \\ ⋮ & \\ {k}_{- n} , & if x ∈ ( - ∞ , {l}_{- n} ) .\end{matrix}$$

19. The system of claim 11, wherein the global average pooling comprises flattening the output to a one-dimensional vector via concatenation.

20. The system of claim 19, wherein combining the inputs to the terminal block comprises generating a final weight matrix of each of the one-dimensional vectors inputted to the terminal block.
